(19) United States
(12) Patent Application Publication
(10) Pub. No.: US 2004/0173044 A1
(43) Pub. Date: Sep. 9, 2004

(54) Device for actuating parking brakes in motor vehicles

(76) Inventor: Ulf Braker, Berlin (DE)

Correspondence Address: Davidson Davidson & Kappel, 14th Floor, 485 Seventh Avenue, New York, NY, 10018, US

(21) Appl. No.: 10/480,189

(22) PCT Filed: Jun. 4, 2002
(86) PCT No.: PCT/DE02/02028

(30) Foreign Application Priority Data
Jun. 9, 2001 (DE) 201 09 710.9

(51) Int. Cl. G05G 1/14

(52) U.S. Cl. 74/512

(57) ABSTRACT

The invention relates to a device for actuating parking brakes in motor vehicles, comprising an actuating lever (1) which is rotatably mounted around an axis (2) in relation to the body of the vehicle, a drum (3) which extendsin an axial manner and is arranged co-axially in relation to the axis (2), in addition to a spring element (4) which is rotationally fixed in relation to the axis (2) and which can be supported against an internal peripheral wall (3a) of the drum, said drum (3) being fixed to the actuation lever (1).

The invention relates to a device for actuating parking brakes in motor vehicles in accordance with the precharacterizing clause of claim 1.

In the case of the actuating arrangements for parking brakes, in particular foot-operated parking brakes and hand brakes, which arrangements are known in practice from building motor vehicles, the brake is locked by means of the actuating lever being locked, the actuating lever generally being locked by means of a ratchet in accordance with the tooth and locking pawl principle. This generally necessitates a large number of movable components shaped in a complicated manner and made from a partly hardened material. In addition, the tooth and locking pawl principle does not permit infinitely variable fastening of an actuating lever.

DE 33 43 268 A1 describes a device for actuating a parking brake of motor vehicles, comprising an actuating lever which can be pivoted about a pivot axis, a drum which can be rotated by the actuating lever, and a helical spring which is arranged on the drum, has a loose and a fixed end and the coils of which surround the circumferential surface of the drum in such a manner that, when the actuating lever is automatically pivoted in the direction of its brake release position, they position themselves frictionally against the circumferential surface of the drum and block it. In this arrangement, a tooth and locking pawl principle is avoided in favor of an infinitely variable solution based on a frictional connection. A disadvantage of the above-described arrangement is that the helical spring rests on the outer circumferential surface of the drum. In order to avoid malfunctions, for example caused by dirt accumulations containing oil or grease, extensive measures are required for encapsulating the helical spring or the outer circumferential surface of the drum. In addition, in the above-described arrangement the fixed end of the helical spring is, in principle, subjected to a tensile load, which means that the problem of securely fixing the end which is subjected to a tensile load has to be solved either by complicated fixing means or by structural measures for transferring the application of force.

U.S. Pat. No. 5,275,262 shows a device for foot-operated parking brakes, in which a brake is fastened by an opposed expansion of a helical spring which is arranged in a hollow cylinder and is supported at one end against the inner wall of the hollow cylinder and at the other end against a bearing shaft. The brake is actuated here by a pedal lever which is connected frictionally to the hollow cylinder by means of a further helical spring engaging around an outer circumferential surface of the hollow cylinder. A disadvantage here is the presence of two springs, which stands in the way of a simple and cost-effective construction. In addition, that end of the helical spring which is supported on the bearing shaft is subjected to high shearing forces when the brake is actuated.

The object of the invention is to provide a device for actuating parking brakes in motor vehicles, the device permitting infinitely variable fastening with the smallest possible number of components.

According to the invention, this object is achieved for a device mentioned at the beginning by the characterizing features of claim 1.

In this case, firstly, the spring element is arranged in a manner such that it can be supported against the inner circumferential wall of the drum, as a result of which a simple encapsulation of the spring element against the accumulation of dirt is made possible at the same time, and, secondly, the actuating lever is connected directly to the drum, with the result that a further helical spring lying on the outside is omitted, so as to save components.

In a preferred development of a device according to the invention, the spring element is advantageously formed as a helical spring from a coiled spring wire, with the arrangement of the helical spring on the inside causing a fixed end of the helical spring to be subjected to a thrust load. This permits a simple and secure fixing of this thrust-loaded, fixed end of the spring wire on an abutment which is secured on the body. It is advantageous here for the fixed end of the spring wire to be led out of the drum through openings in the drum. The abutment is preferably arranged outside the drum, and the end of the spring wire is secured in a simple manner by being clamped in a sleeve which belongs to the abutment secured on the body, is placed at one end or tapers to one end. The greater the inside diameter of the drum, the higher are the retaining forces which can be obtained and the smaller is the angle of slip which occurs at the onset of the retaining action of the spring and about which the actuating lever rotates back when it is released after being actuated. By leading the fixed end of the spring wire through the openings in the drum, reliable support of the fixed end is ensured in a simple manner, even at large drum diameters.

A free end of the spring wire, which end is used for releasing the fastening device, is advantageously fixed in a release lever. The free end is advantageously led out of the drum through openings in the drum, and the release lever is arranged outside the drum. The release lever is fixed in an articulated manner on the body of the vehicle and is connected to a control cable for releasing the parking brake. This enables an advantageous transmission of force from a control cable for releasing the parking brake to the free end of the spring wire of the helical spring. As an alternative to this, provision may be made for the free end of the helical spring to be connected directly to the control cable for releasing the parking brake, with the result that the release lever is omitted, so as to avoid components.

In a preferred refinement of the present invention, the drum and the actuating lever each comprise a separate component, the components being fixed to each other by connecting means, for example screws. This ensures in a simple manner that only the drum consists of a special material suitable for imparting a high degree of friction between the spring element and drum, whereas the actuating lever can consist of a conventional cast material or sheet-metal formed part. A control cable for actuating the brake is fixed in a known manner on the actuating lever. As an alternative to this, the control cable may also be fixed on the drum and, in particular, may revolve the drum in one or more coils.

Since the device according to the invention is of particularly small dimensions both in its diameter and in its extent directed towards the axis, it can be used as a device both for foot-operated parking brakes and for hand brakes.

Further features and advantages of the invention emerge from the exemplary embodiment described below and from the dependent claims.

A preferred exemplary embodiment of a device according to the invention will be explained in greater detail below with reference to the attached drawings.

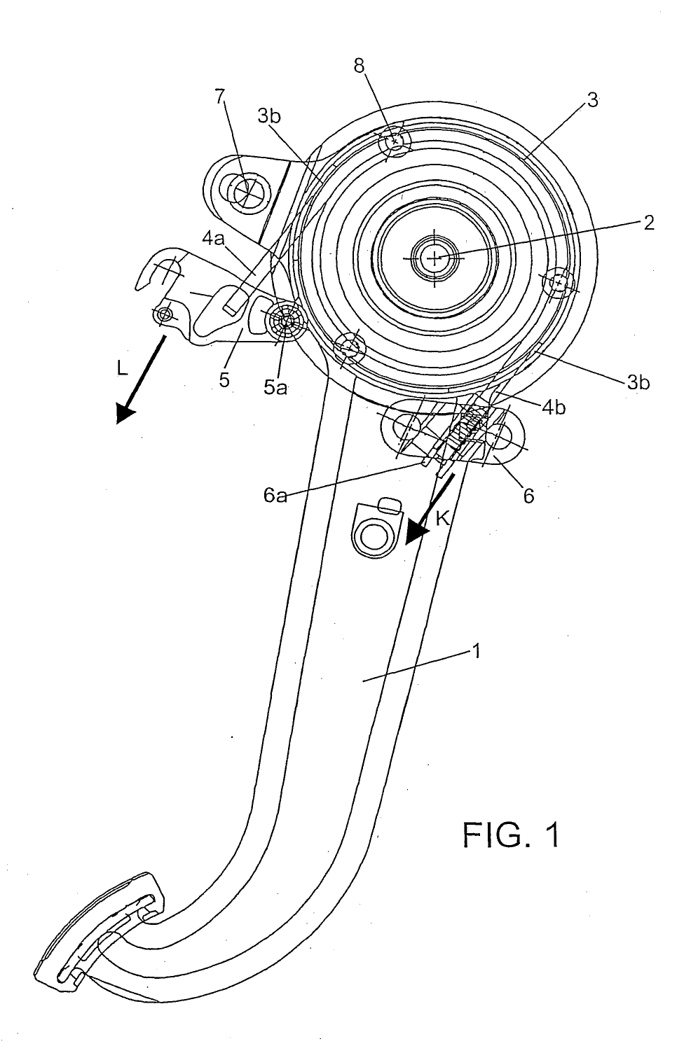

FIG. 1 shows a schematic side view of a device according to the invention which is designed as a foot-operated parking brake.

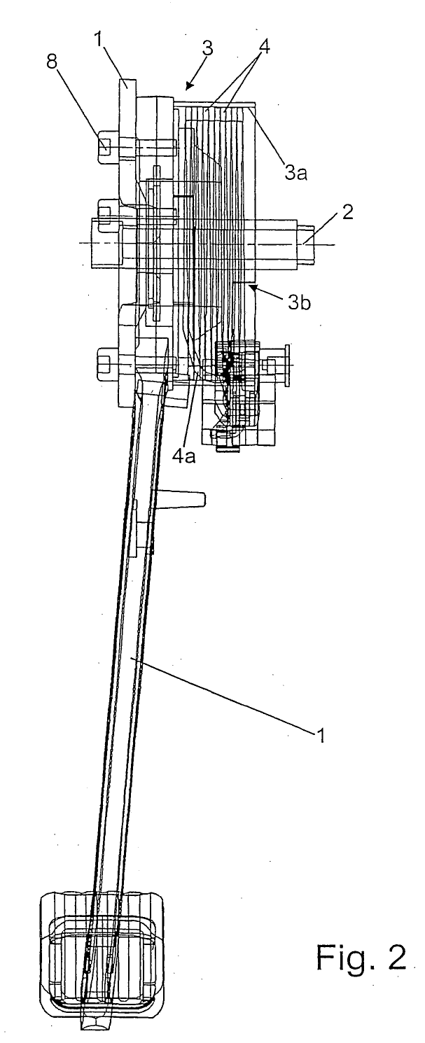

FIG. 2 shows a schematic plan view of a device according to the invention from FIG. 1.

As FIG. 1 and FIG. 2 show, the device comprises an actuating lever 1 which is mounted in a manner such that it can rotate about an axis 2.

A drum 3 is fixed concentrically with the axis 2 on the actuating lever 1 by means of screws 8. The drum 3 extends axially to the axis 2 and has an inner circumferential wall 3a. A helical spring 4, which is coiled from a spring wire, is placed into the drum 3, the outer surfaces of the spring wire bearing frictionally against the inner circumferential wall 3a of the drum 3. The drum 3 has openings 3b through which a free end 4a of the spring wire and a fixed end 4b of the spring wire are led out. The free end 4a of the spring wire is fixed in a release lever 5. The release lever 5 is fixed on the body of the vehicle in a manner such that it can rotate about a joint 5a. The fixed end 4b of the spring wire is fixed in an abutment 6. The abutment 6 is fixed on the body of the vehicle and comprises a sleeve 6a, into which the fixed end 4b of the spring wire can be inserted in a clamping manner.

Holding means 7 for fixing a control cable for actuating a brake (not illustrated) of the motor vehicle are situated on the actuating lever 1.

The invention functions as follows:

When the actuating lever 1 is actuated, the lever, and the drum connected in a rotationally fixed manner to it, is pivoted anticlockwise (see FIG. 1) about the axis 2. The friction along the outer circumferential surface of the helical spring 4 is directed here in such a manner that the spring tapers radially as it is carried along by the friction and secured at the same time in the abutment 6, with the result that the frictional force on the inner circumferential wall 3a of the drum 3 decreases and the actuating lever can be moved. In the process, the control cable (not illustrated) for actuating the brake is tightened and the brake actuated. When the actuating lever is released, the control cable of the brake exerts a driving-back force on the actuating lever, which force would result in the actuating lever rotating clockwise. However, the helical spring 4, which is prestressed radially outward, is carried along here in a direction in which it expands radially outward on account of the fixed end 4b being supported in the abutment 6. This results in the actuating lever being blocked as it is moved in the clockwise direction. The force is transmitted via the fixed end 4b of the helical spring 4 in the direction of the arrow K to the sleeve 6a of the abutment 6 which is secured on the body.

In order again to release the parking brake which is blocked in such a manner, the free end 4a of the helical spring 4 is pulled by means of a release cable (not illustrated) via the release lever 5 along the arrow direction L. This causes the helical spring 4 to taper, which leads to a relaxing of the frictional force on the inner circumferential wall 3a. As a result, the actuating lever becomes free again and is caused by the driving-back force of the brake or by further restoring springs (not illustrated) to move in the clockwise direction into its starting position.

1. A device for actuating parking brakes in motor vehicles, comprising
an actuating lever (1) which is mounted in a manner such that it can rotate relative to the body of the motor vehicle about an axis (2),
a drum (3) which is arranged concentrically with the axis (2) and extends axially, and
a spring element (4) which is rotationally fixed with respect to the axis (2) and can be supported against an inner circumferential wall (3a) of the drum, characterized in that the drum (3) is connected in a rotationally fixed manner to the actuating lever (1).

2. The device as claimed in claim 1, characterized in that the spring element is formed as a helical spring (4) from a coiled spring wire, the coils of the spring wire bearing with their radially outwardly directed surfaces against the inner circumferential wall (3a).

3. The device as claimed in claim 2, characterized in that ends (4a, 4b) of the spring wire are led out of the drum (3) in a manner directed essentially tangentially away from the helical spring (4) by means of openings in the drum (3).

4. The device as claimed in claim 2 or 3, characterized in that a free end of the spring wire is fixed to a release lever (5).

5. The device as claimed in one of claims 2 to 4, characterized in that a fixed end of the spring wire is connected by means of an abutment (6) to an element of the motor vehicle, which element is secured on the body.

6. The device as claimed in claim 5, characterized in that the fixed end of the spring wire is inserted in a clamping manner into a sleeve (6a) which is formed on the abutment and is closed or tapered at one end.

7. The device as claimed in one of claims 1 to 6, characterized in that a holder (7) for securing a control cable of the parking brake is provided on the actuating lever.

8. The device as claimed in one of claims 1 to 7, characterized in that the actuating lever (1) and the drum (3) are designed as two separate components which can be fixed on each other by connecting means (8).

9. The device as claimed in one of claims 1 to 8, characterized in that the drum (3) consists of a different material than the actuating lever (1).

10. The device as claimed in one of claims 1 to 9, characterized in that the actuating lever (1) is formed as an actuating lever of a hand brake of a motor vehicle.

11. The device as claimed in one of claims 1 to 10, characterized in that the actuating lever (1) is formed as a foot pedal of a foot-operated parking brake of a motor vehicle.
